(19) United States
(12) Patent Application Publication
(10) Pub. No.: US 2024/0020080 A1
(43) Pub. Date: Jan. 18, 2024

(54) HANDLING LOCAL APPLICATION EVENTS WHILE WORKING ON REMOTE DESKTOPS

(71) Applicant: VMware, Inc., Palo Alto, CA (US)

(72) Inventor: Lin LV, Beijing (CN)

(73) Assignee: VMware, Inc., Palo Alto, CA (US)

(21) Appl. No.: 17/901,864

(22) Filed: Sep. 2, 2022

(30) Foreign Application Priority Data
Jul. 13, 2022 (WO) PCT/CN2022/105436

(51) Int. Cl. G06F 3/14; H04L 67/143; H04L 41/069; G06F 3/0482; G06F 9/451

(52) U.S. Cl. CPC G06F 3/1454; H04L 67/143; H04L 41/069; G06F 3/0482; G06F 9/452; G06F 3/04817

(57) ABSTRACT

A method enables events associated with local applications to be handled at a user device while a remote desktop is being used at the user device. A notification of an event is presented on a display screen of the user device, over the remote desktop. The notification prompts a user to handle the event now or handle the event later. In response to the user selecting to handle the event now, a window of a local application associated with the event is displayed over the remote desktop and may be used by the user to handle the event.

### CROSS-REFERENCE TO RELATED APPLICATION

The present application claims the benefit of Patent Cooperation Treaty (PCT) Application No. PCT/CN2022/105436, filed Jul. 13, 2022, which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources in a virtualized computing environment may include central processing unit (CPU) resources, memory resources, storage resources, network resources, etc.

One example use of a virtualized computing environment is for a virtual desktop infrastructure (VDI) implementation, which is a type of desktop virtualization that allows a remote desktop to run on VMs that are provided by a hypervisor on a host. A user/client uses the operating system (OS) and applications (which reside and execute at the VM) via an endpoint device (client device) of the user, just as if the OS/applications were actually running locally on the endpoint device, when in reality the OS/applications are running on the remote desktop.

Working remotely on a daily basis, such as via remote desktops, has become more common in recent years, As an example, a user working from home (or other location remote from a primary office) may operate multiple local devices (user/client devices), such that the user may use these different/multiple local devices to connect to multiple respective remote desktops, or may use different local devices for respective different types of work, applications, projects, etc. However, there are drawbacks associated with concurrently using remote desktops along with local applications installed on the local devices.

### BRIEF DESCRIPTION OF DRAWINGS

FIG. 1 is a schematic diagram illustrating an example virtualized computing environment that can implement a virtual desktop infrastructure (VDI) having capability to handle local application events in conjunction with operating a remote desktop;

FIG. 2 is a schematic diagram illustrating client and agent devices for the virtualized computing environment of FIG. 1;

FIG. 3 is a diagram illustrating an example notification of an event associated with a local application;

FIG. 4 is a diagram illustrating an example of the event of FIG. 3 being handled;

FIG. 5 is a schematic diagram illustrating components of a client and agent that cooperate to provide notification and handling of events; and

FIGS. 6, 7, and 8 are flow diagrams of an example method to handle application events when operating a remote desktop.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses drawbacks associated with concurrently using local applications (installed at a user local device or other client device) and a remote desktop rendered on the client device. For example, the user may have an application such as a collaboration/messaging application (e.g., Slack or Microsoft Teams or Outlook) locally installed in the client device and which is being run by the local operating system (OS) on the client device. Meanwhile, the user may also be concurrently working on a remote desktop rendered on the display screen of the client device. In this scenario, it may be difficult for the user to be informed when an event (such as an incoming call/message) occurs in the local application since the event (e.g., the incoming call/message) is managed by the local OS and the display screen of the client device is fully covered by the rendered remote desktop.

As another example, the user may be concurrently using multiple client devices, and each of these client devices respectively connects to and renders a remote desktop. If a Teams call or Slack message is incoming on a client device A, but the user is working on a client device B, the user may not be informed of this event, especially if the client devices are not located closely to each other (e.g., the client devices A and B may be separated by a great distance across the same room, or located in different rooms). It is also common for a user to mute the speaker on a client device so as to avoid bothering colleagues or family members when the user is working. As a result of the muted speaker, the user may not get informed by the sound of an incoming call or new message.

To address the above and other drawbacks, the embodiments disclosed herein enable users to get visually informed when an event associated with a local application occurs, and to respond to such event occurring on the client device when the user is concurrently working on remote desktop(s) on the same and/or other client device(s). The user can be informed/notified of the event(s) even though the event(s) occur on some other client device, for example so long a remote desktop application (e.g., a remote desktop client) is launched on that other client device and connected to a connection server of the VDI.

### Computing Environment

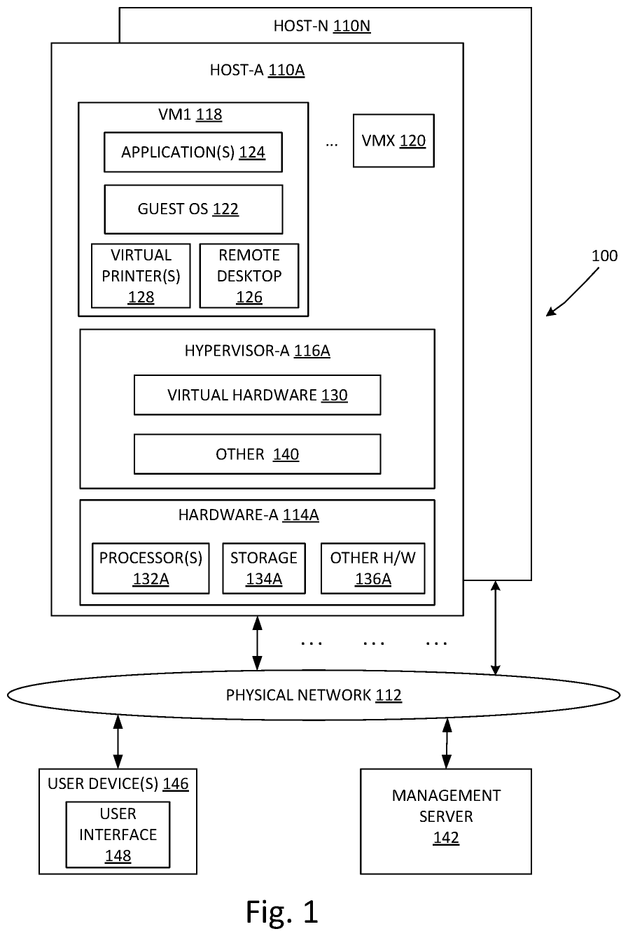

To further explain the details of how a user may be notified/informed regarding events, reference is first made herein to FIG. 1, which is a schematic diagram illustrating an example virtualized computing environment 100 that can implement virtual desktop infrastructure (VDI) having capability to handle local application events in conjunction with operating a remote desktop. Depending on the desired implementation, virtualized computing environment 100 may include additional and/or alternative components than that shown in FIG. 1.

In the example in FIG. 1, the virtualized computing environment 100 includes multiple hosts, such as host-A 110A host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of the host-A 110A. Each of the other host-N 110N can include substantially similar elements and features.

The host-A 110A includes suitable hardware 114A and virtualization software (e.g., a hypervisor-A 116A) to support various virtual machines (VMs). For example, the host-A 110A supports VM1 118 . . . VMX 120, wherein X (as well as N) is an integer greater than or equal to 1. In practice, the virtualized computing environment 100 may include any number of hosts (also known as computing devices, host computers, host devices, physical servers, server systems, physical machines, etc.), wherein each host may be supporting tens or hundreds of virtual machines. For the sake of simplicity, the details of only the single VM1 118 are shown and described herein.

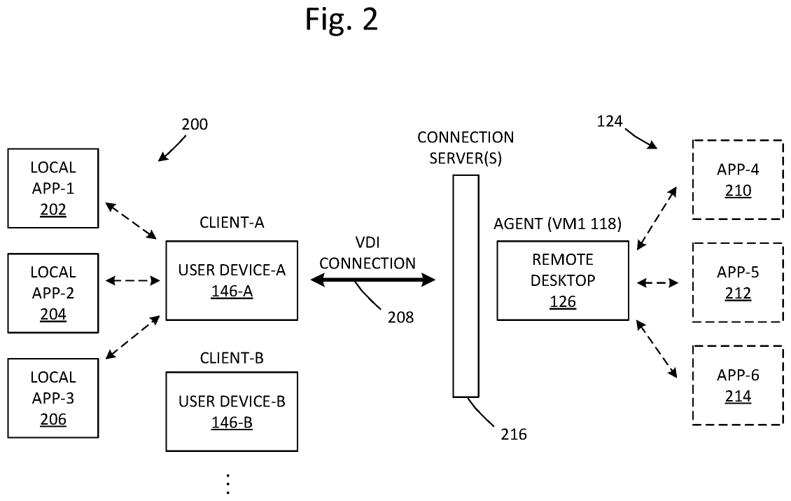

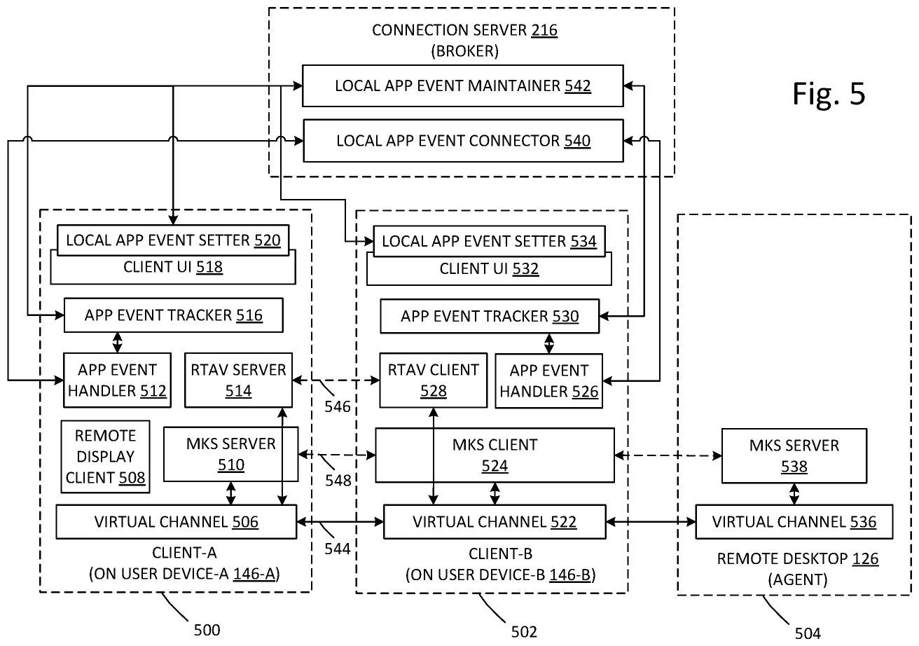

VM1 118 may be an agent-side VM that includes a guest operating system (OS) 122 and one or more guest applications 124 (and their corresponding processes) that run on top of the guest OS 122. Using the guest OS 122 and/or other resources of VM1 118 and the host-A 110A, VM1 118 may generate a remote desktop 126 (virtual desktop) that is operated by and accessible to one or more client-side user device(s) 146 (e.g., a client device or a local device) via the physical network 112. One or more virtual printers 128 also may be instantiated in VM1 118 and/or elsewhere in the host-A 110A, and may correspond to one or more physical printers (not shown) at the user device 146. VM1 118 may include other elements, such as code and related data (including data structures), engines, etc., which will not be explained herein in further detail, for the sake of brevity. The user device 146 may include a user interface 148 and other components (explained in more detail in FIGS. 2 and 5) to support the use of the user device 146 in cooperation with the virtual desktop 126 and other elements of VM1 118.

According to various embodiments, VM1 118 may operate as an agent that provides the remote desktop 126 (and other remote desktop features) to one or more of the user device 146. For instance, the agent can cooperate with client software (referred to at times herein as a remote desktop application, client application, or client, installed at the user device 146) to establish and maintain a remote desktop connection between VM1 118 and the user device 146 for purposes of enabling the user to operate the user interface 148 in order to use the remote desktop 126. In some embodiments, the agent can be a sub-component of VM1 118. Examples of the agent and client software are the Horizon agent and the Horizon client, respectively, of VMware, Inc. of Palo Alto, California. One or more connection servers can broker or otherwise manage communications between the agent (e.g., a Horizon agent) and the client software (e.g., a Horizon client) over a VDI connection 208 (shown in FIG. 2) provided by the physical network 112. A management server 142 and/or other server(s)/device(s) can operate as the connection server in some implementations.

The hypervisor-A 116A may be a software layer or component that supports the execution of multiple virtualized computing instances. The hypervisor-A 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs. The hypervisor-A 116A may include other elements (shown generally at 140), including tools to provide resources for and to otherwise support the operation of the VMs.

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and application(s) in the virtual machine, such as the guest OS 122 and the application(s) 124 (e.g., a word processing application, accounting software, a browser, etc.) in VM1 118. Corresponding to the hardware 114A, the virtual hardware 130 may include a virtual CPU, a virtual memory (including agent-side caches used for print jobs for the virtual printers 128), a virtual disk, a virtual network interface controller (VNIC), etc.

The management server 142 of one embodiment can take the form of a physical computer with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster.

The management server 142 may be communicatively coupled to host-A 110A . . . host-N 110N (and hence communicatively coupled to the virtual machines, hypervisors, hardware, etc.) via the physical network 112. In some embodiments, the functionality of the management server 142 may be implemented in any of host-A 110A . . . host-N 110N, instead of being provided as a separate standalone device such as depicted in FIG. 1.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

FIG. 2 is a schematic diagram illustrating client and agent devices for the virtualized computing environment 100 of FIG. 1. More specifically, FIG. 2 shows a client-A (e.g., a Horizon client running on a user device-A 146-A), an agent (e.g., the VM1 118 and/or a component thereof, such as a Horizon agent, that provides the remote desktop 126 and which runs on a host), and their associated applications that may be displayed on their respective desktops.

At a client side 200, the user device-A 146-A may have local applications (APPs) installed on it. These applications may include a local application-1 202, a local application-2 204, a local application-3 206, etc. These local applications (e.g., their respective icons or launched files/interfaces) may in turn be presented on a local desktop rendered on a display screen of the user device-A 146-A. Examples of these local applications (which may generate their own respective events) may include but not be limited to Slack, Microsoft Teams, Outlook, and/or other types of messaging/collaboration applications, as well as other locally installed applications such as a calendar application, word processing application, spreadsheet application, games, browser, etc.

At the client side 200, there may be still further user devices operated by the user, such as a user device-B 146-B, etc. that have installed therein and that run their own respective local applications (not shown in FIG. 2), in a manner analogous to the local applications 202-206 of the user device-A 146-A. The user device-B 146-B may have installed therein a client-B (e.g., a Horizon client) for establishing and conducting remote desktop sessions with the VDI at the agent side.

The remote desktop clients at the respective user devices (e.g., at the user device-A 146-A, the user device-B 146-B, etc.) may use one or more VDI connections 208 to establish and conduct a remote desktop session with the VDI at the agent side. One or more connection servers 216 at the agent side may manage these connections to respective remote desktops 126 (e.g., for brokering communications, load balancing purposes, etc.).

At the agent side, the remote desktop 126 may provide applications installed/running thereon (e.g., the applications 124 of FIG. 1). These applications on the remote desktop 126 may include an application-4 210, an application-5 212, an application-6 214, etc. These applications (e.g., their respective icons or launched files/interfaces) may in turn be presented on a window of the remote desktop 126 rendered on the display screen of the user device 146, when the user device 146 accesses the remote desktop 126.

### Handling of Events Associated with Local Applications

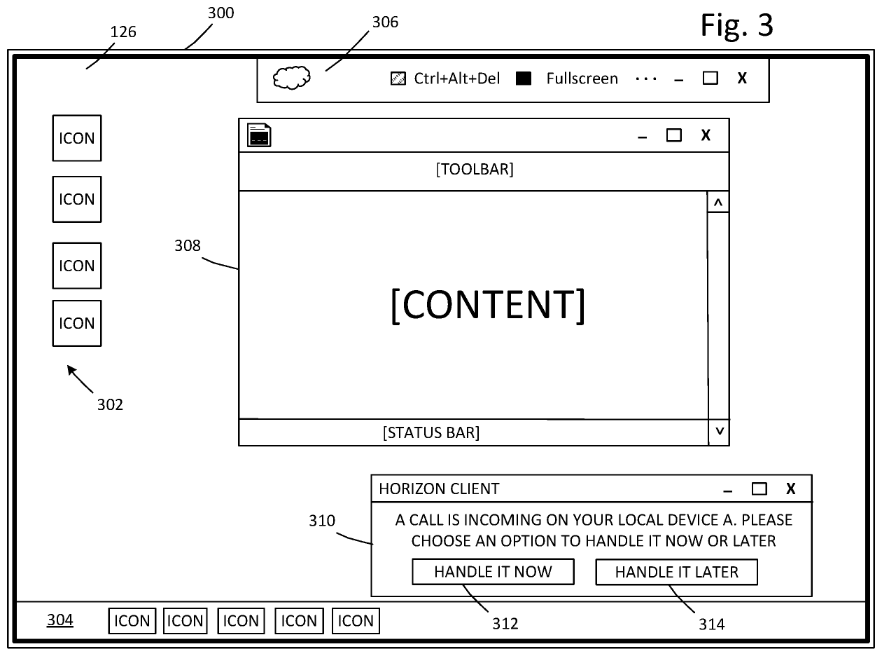

FIG. 3 is a diagram illustrating an example notification of an event associated with a local application. More specifically, a user may be conducting a remote desktop session on the user device-A 146-A, in which the remote desktop 126 occupies the entire real estate of a display screen 300 of the user device 146. Among other things and during the course of the remote desktop session, the real estate of the remote desktop 126 may display a plurality of icons 302 corresponding to remote desktop applications (e.g., the applications 210-214 of FIG. 2), a task bar 304, a menu bar 306, a window 308 of any open remote desktop application, etc.

According to various embodiments, when an event associated with a local application (such as a Teams call) occurs on one or more of the user devices 146, a notification 310 is presented on the particular user device-A 146-A that is currently being operated by the user. The notification 310 may take the form of a pop-up window or dialog box, for example, that is rendered on the remote desktop 126, such as in the lower right corner as depicted in FIG. 3. The notification 310 may be generated by the client (e.g., a Horizon client) installed at that user device, and may prompt the user to handle the event now or later.

For example, if the event is an incoming call (e.g., a Teams call), the notification 310 may present text that says “A CALL IS INCOMING ON YOUR LOCAL DEVICE A. PLEASE CHOOSE AN OPTION TO HANDLE IT NOW OR LATER”, along with a selection button 312 (“HANDLE IT NOW”) and a selection button 314 (“HANDLE IT LATER”). The user may make a selection, such as by clicking on one of these buttons 312 or 314, to respectively handle the event now or ignore the event.

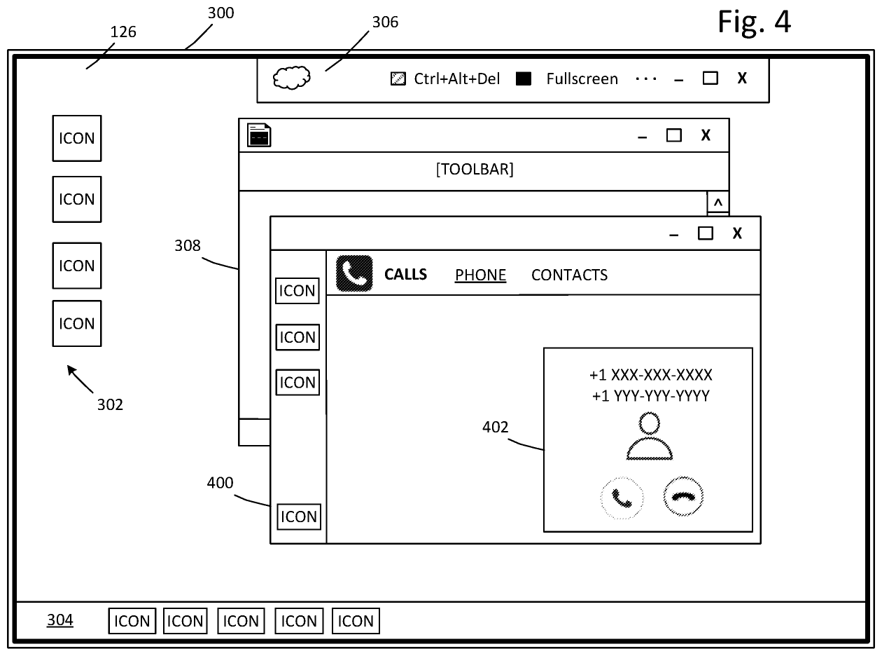

FIG. 4 is a diagram illustrating an example of the event of FIG. 3 being handled. For example, if the user has clicked on the button 312 so as to handle the event now, a window 400 of the local application is launched and is rendered over the remote desktop 126. According to various embodiments, only the window 400 of the local application associated with the event being handled is displayed over the remote desktop 126. Other local applications and/or their respective windows remain obscured by the remote desktop 126.

The window 400 may in turn include a sub-window or other interface 402, where the user may conduct the phone call (in this example). In some embodiments, the window 400 may be rendered over (superimpose) the window 308 of the remote application running on the remote desktop 126, such as depicted in FIG. 4. It is also possible in some implementations to minimize the window 308 of the remote application when the window 400 of the local application is rendered, or to even close out the remote application and its window 308 at least temporarily while the window 400 of the local application is active.

The window 400 of some embodiments may be a cropped window, in that only the window 400 of the local application (residing on user device-A 146-A) is presented on the display screen of the user device-A 146-A. In this manner, the entire local desktop of user device-A 146-A (and/or windows of other active local applications residing on the user device-A 146-A) is not presented on the display screen of the user device-A 146-A.

Furthermore, the window 400 may be a window of a local application that is resident on the user device-A 146-A that is being currently viewed/operated by the user, or the window 400 may be a window of a local application that is resident on some other user device (e.g., the user device-B 146-B) but the window 400 is rendered on the display screen of the user device-A 146-A. Thus, an event that occurs at one user device may be viewed/handled at some other user device.

FIG. 5 is a schematic diagram illustrating components of a client and an agent that cooperate to provide notification and handling of events. More specifically, FIG. 5 shows example components of remote desktop clients (e.g., Horizon clients), a remote desktop agent (e.g., Horizon agent), and other components/devices of FIG. 2 that may provide the notification and handling of events such as depicted in FIGS. 3 and 4 above. Various components of the clients, agent, etc. of FIG. 5 may be embodied as software or other computer-readable instructions stored on computer-readable media and executable by one or more processors, may be embodied in hardware, and/or may be embodied as a combination of hardware and software.

A client-A 500 may reside on the user device-A 146A, and a client-B 502 may reside on the user device-B 146B. An agent 504 is configured to provide one or more remote desktops 126 and related functionality to the client-A 500 and the client-B 502. The connection server 216 operates to broker communications between the agent 504 and each of the client-A 500 and the client-B 502.

The client-A 500 may comprise, among other things, various components such as a virtual channel 506, a remote display client 508, a mouse-keyboard-screen (MKS) server 510, an application event handler 512, a real-time-audio-video (RTAV) server 514, an application event tracker 516, a client UI 518, and a local application event setter 520. The client-B 502 may comprise, among other things, various components such as a virtual channel 522, MKS client 524, an application event handler 526, a RTAV client 528, an application event tracker 530, a client UI 532, and a local application event setter 534. Same/similar components of the client-A 500 and the client-B 502 may perform the same/similar operations described below.

The agent 504, may comprise, among other things, various components such as a virtual channel 536 and a MKS server 538. The connection server 216 may comprise, among other things, various components such as a local application event connector 540 and a local application event maintainer 542.

The virtual channels 506, 522, and 536 are used for communicating data, graphics, files etc. between clients and agent(s). An RTAV server may be a component in the agent 504, but may be additionally deployed (as the RTAV server 514) on the client-A 500 so that the RTAV server 514 can work (shown at 546 in FIG. 5) with the RTAV client 528 on the other client-B 502 to encode/decode AV data and transfer the AV data between these two clients.

The local application event setter 520 is implemented to display the client UI 518 on the client-A 500 so that the user can use the client UI 518 to configure which local applications and which application events are to be tracked/monitored. Analogous operations can be performed for the client-B 502 using the local application event setter 534 and the client UI 532 at the client-B 502. Once this configuration is completed, the configuration information is submitted to the local application event maintainer 542 resident on the connection server 216 and is stored on the connection server 216.

The application event tracker 516 of the client-A 500 is configured to monitor for local application events and send the event(s) to the application event handler 512 for further handling. For example, once the monitored application event occurs, the application event tracker 516 pushes (or provides information pertaining to) the event to the application event handler 512 for further actions. Analogous operations may be performed by the application event tracker 530 and application event handler 526 residing at the client-B 502.

According to some embodiments, the application event tracker 516 can be implemented by leveraging dynamic link library (DLL) injection technology that injects the application event tracker 516 to a local application's process so as to hook the application's functions, in a manner that the application event tracker 516 can be notified when some application function related events occur. As another example, the application event tracker 516 can be implemented by leveraging a notification feature of an OS. For instance, the application event tracker 516 may use VVindows' push notification services to get application event notifications from the local applications that are using these notification services to publish application events. Other methods for monitoring/tracking events associated with local applications can be used.

When the application event handler 512 receives an application event (and/or information pertaining to the event) from the application event tracker 516, the application event handler 512 first checks if the client-A 500 on the current user device-A 146-A has a connection to a remote desktop 126. If connected, then the application event handler 512 displays a notification (e.g., the notification 310 shown in FIG. 3) over the remote desktop 126 to inform the user that there is local application event and to prompt the user for a handling decision. For example and as depicted in FIGS. 3 and 4, the user can choose to bring up the local application's window 400 by clicking on the button 312, or to ignore the application event by clicking on the button 314.

If user chooses to handle the event, the client-A 500 displays the local application's window 400 over the remote desktop 126 so that the user can operate the local application to handle the event, such as by answering a call, replying to a message or email, etc. Afterwards, the user can dismiss the window 400 by closing the window 400 or by minimizing the window 400, so that the user can resume working on the remote desktop 126.

If user is connected to multiple remote desktops 126 on this user device-A 146-A (for example, users may have multiple screen monitors and each monitor has one remote desktop 126 connected/presented on the monitor), each remote desktop 126 may have a respective overlying notification 310 so as to ensure that the user does not miss the application event. According to some embodiments, the notification 310 disappears after expiration of some amount of time (e.g., after several seconds) if the user does not choose any of the options from the buttons 312 and 314.

Furthermore, the application event handler 512 checks with the connection server 216 to determine if the user has other remote desktops 126 connected with other user devices (e.g., the user device-B 146-B). R so, then the application event handler 512 sends the application event related information and connection information for this client-A 500 to the local application event connector 540 residing on the connection server 216, and the local application event connector 540 then relays this information to the client-B 502 on the user device-B 146B and/or to other clients on other user devices.

When the application event handler 526 on the user device-B 146-B receives the event information, the application event handler 526 and/or other component of the client-B 502 displays the notification 310 on all connected remote desktops 126 on the user device-B 146-B. if the user sees this notification 310 and chooses to handle the application event, the application event handler 526 on this user device-B 146-B will request the client-B 502 to establish one or more connections (shown at 544 in FIG. 5) between the user device-B 146-B and the original user device-A 146-A (where the application event originated), so that the graphics and content of the local application's window 400 can be transferred from the user device-A 146-A to the user device-B 146-B.

Once the connection 544 is established successfully, the application event handler 526 will request the client-B 502 to display the window 400 above the remote desktop 126 so that the user can handle the application event from the user device-B 146-B. The connection 544 between these two user devices is destroyed once the user doses or minimizes the application's window 400.

The MKS server 538 is a component in the agent 504, and is also deployed as the MKS server 510 on the client-A 500 so that this MKS server 510 can work (shown at 548 in FIG. 5) with the MKS client 524 on the other client-B 502 to transfer mouse events, keyboard events, and graphical data between these two clients. Also, MKS server 538 and/or the MKS client 524 may be configured to crop graphical data so as to only keep the data of application's window 400. As a result, the user on another user device will only see the application's window 400 instead of the whole local desktop of the user device where the application event originates.

With respect to the connection server 216, the local application event maintainer 542 is configured to maintain the application event configuration information for each user. The local application event maintainer 542 receives and stores the application event configuration information from each client. Further, the local application event maintainer 542 pushes the configuration information to clients when users launch a client on a user device and logs into the connection server 216.

In addition to the features/operations previously explained above, the local application event connector 540 is also configured to receive application event information from a client that does not have an active connection to a remote desktop 126 but still has a connection with the connection server 216. Thus, the local application event connector 540 can relay the application event to another client that currently has an active connection to a remote desktop 126.

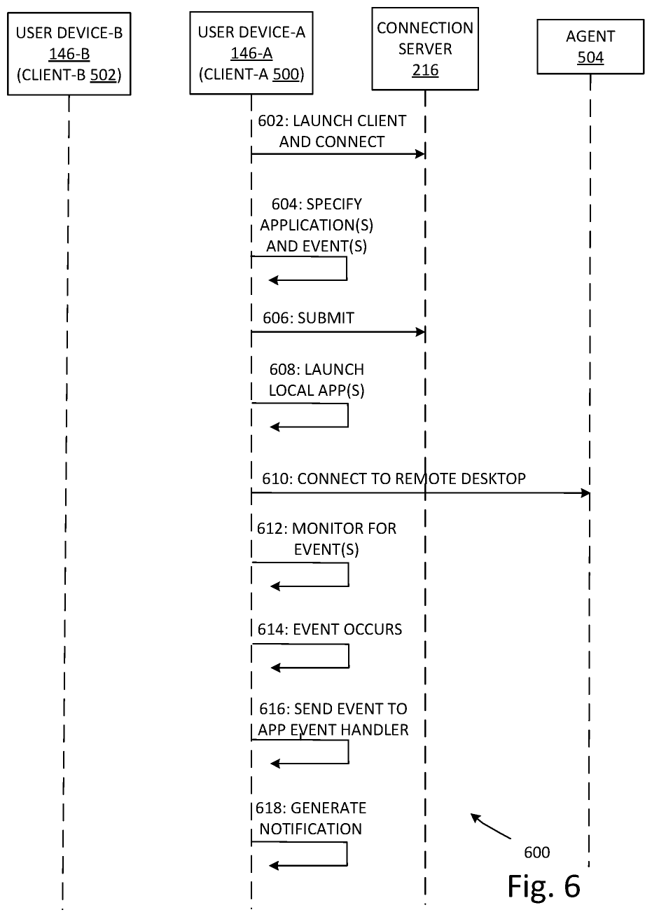

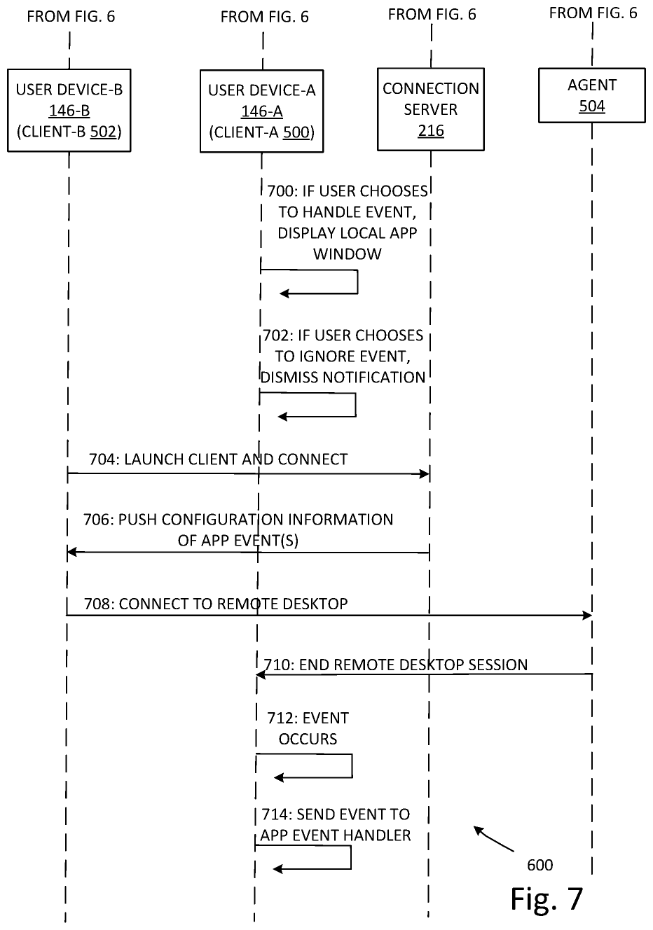

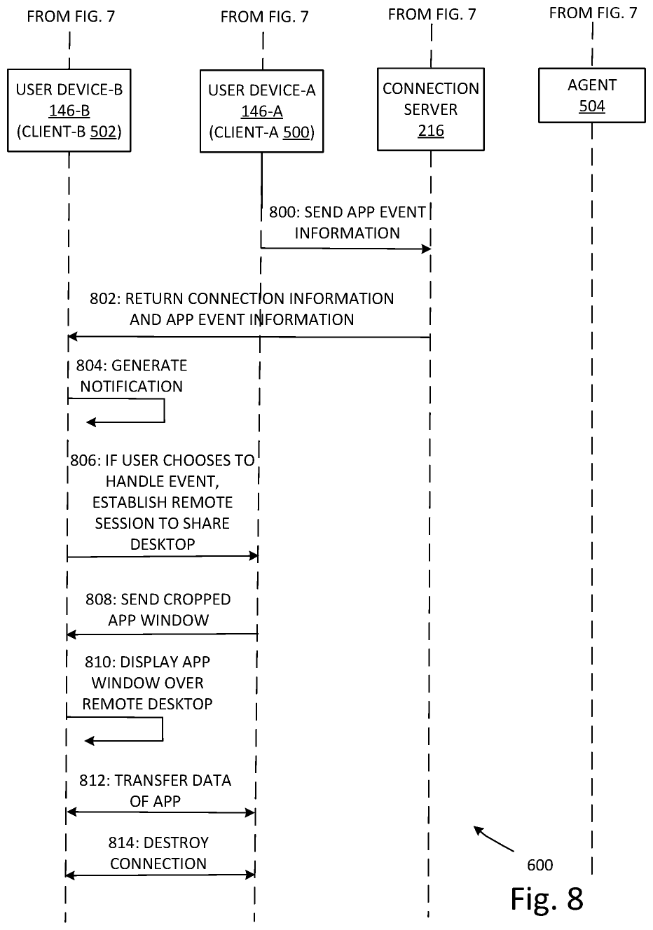

FIGS. 6, 7, and 8 are flow diagrams of an example method 600 to handle application events when operating a remote desktop. Example method 600 may include one or more operations, functions, or actions illustrated at 602 to 814, in which the operations of FIG. 6 continue into FIG. 7, and the operations of FIG. 7 continue into FIG. 8. The various operations of the method 600 and/or of any other process(es) described herein may be combined into fewer operations, divided into additional operations, supplemented with further operations, and/or eliminated based upon the desired implementation. In one embodiment, the operations of the method 600 and/or of any other process(es) described herein may be performed in a pipelined sequential manner. In other embodiments, some operations may be performed out-of-order, in parallel, etc.

According to one embodiment, the method 600 may be performed by the client-A 500 and client-B 502, in cooperation with at least one agent (e.g., the agent 504) and the connection server 216 for some operations. In other embodiments, various other elements in a computing environment may perform, individually or cooperatively, the various operations of the method 600.

At 602 (“LAUNCH CLIENT AND CONNECT”), the user at the user device-A 146-A launches the client-A 500 so as to initiate a remote desktop session. As part of this process, the client-A 500 connects with the connection server 216. At 604 (“SPECIFY APPLICATION(S) AND EVENT(S)”), the user operates the local application event setter 520 and the client UI 518 to specify/configure the local application(s) and corresponding event(s) that are to be monitored and for which a notification is to be provided when the event(s) occur. At 606 (“SUBMIT”), the configuration information is submitted from the client-A 500 to the connection server 216.

At 608 (“LAUNCH LOCAL APP(S)”), the user launches the local applications of the user device-A 146-A that are to be monitored. Such applications may include Teams, Outlook, Slack, etc. At 610 (“CONNECT TO REMOTE DESKTOP”), the client-A 500 connects to the remote desktop 126 provided by the agent 504. The remote desktop 126 is then displayed on the display screen of the user device-A 146-A, and the user may begin using remote applications on the remote desktop 126 during this remote desktop session (e.g., the user begins working remotely).

At 612 (“MONITOR FOR EVENT(S)”), the client-A 500 instructs the application event tracker 516 to begin monitoring the local applications on the user device-A 146-A that have been configured for event monitoring. At 614 (“EVENT OCCURS”), the application event tracker 516 determines/detects that an event has occurred on the user device-A 146-A for one of the monitored local applications. For example, the application event tracker 516 may detect that there is an incoming Teams call.

At 616 (“SEND EVENT TO APP EVENT HANDLER”), the application event tracker 516 pushes the detected event (and/or sends information pertaining to the detected event) to the application event handler 512. At 618 (“GENERATE NOTIFICATION”), the application event handler 512 generates the notification 310 that is displayed over the remote desktop 126 on the display screen of the user device-A 146-A. For example and as depicted in FIG. 3, the notification 310 may be in the form of a pop-up window that is displayed at a lower right corner of the display screen and that prompts the user to click on the selection button 312 (for handling the event now) or the selection button 314 (for ignoring or handling the event later).

Turning now and continuing to FIG. 7, the user has clicked on one of the selection buttons 312 or 314. At 700 (“IF USER CHOOSES TO HANDLE EVENT, DISPLAY LOCAL APP WINDOW”), the window 400 of the local application that has experienced the event is displayed over the remote desktop 126, if the user has clicked the button 312. As depicted in the example of FIG. 4, the window 400 may be a cropped window in that only the window 400 of the local application is displayed, rather than displaying other portions of the local desktop 300 and/or content of other local applications. In this manner, the user may begin to immediately handle the event (e.g., conduct a meeting/call) without having to return to or otherwise display the UI of the local OS.

On the other hand, if the user has chosen to ignore or handle the event later, such as by clicking on the button 314 or by not timely clicking on any selection button provided by the notification 310, the notification 310 is dismissed and the user may continue working on the remote desktop 126, at 702 (“IF USER CHOOSES TO IGNORE EVENT, DISMISS NOTIFICATION”).

The user may have other user devices, such as the user device-B 146-B, from which the user wishes to conduct a remote desktop session. At 704 (“LAUNCH CLIENT AND CONNECT”), the user at the user device-B 146-B launches the client-B 502 so as to initiate a remote desktop session. As part of this process, the client-B 502 connects with the connection server 216. At 706 (“PUSH CONFIGURATION INFORMATION OF APP EVENT(S)”), the connection server 216 pushes the configuration information (which was previously provided by the client-A 500 to the connection server at 606 in FIG. 6) for application events to the client-B 502.

At 708 (“CONNECT TO REMOTE DESKTOP”), the client-B 502 completes the establishment of the remote desktop session by connecting to the agent 504 so as to present the remote desktop 126 on the display screen of the user device-B 146-B. The user can thus begin using the remote desktop 126 at the user device-B 146-B so as to work remotely. Having established this remote (second) desktop session for the client-B 502 at the user device-B 146-B, the remote (first) desktop session for the client-A at the user device-A 146-A is ended/disconnected, at 710 (“END REMOTE DESKTOP SESSION”).

According to various embodiments, when the user on the user device-B 146-B wants to connect to a remote desktop, it is not required to connect the user device-B 146-B to the same remote desktop that the user device-A 146-A is connected to and steal the existing remote desktop session. Even if the user on user device-B 146-B connects to a new remote desktop, the event handling solution still works properly since a local application event will be sent to all connected remote desktops for this user via the application event handler 512 and the connection server 216. The connection server 216 knows which remote desktops are connected and which are disconnected since one of responsibilities of the connection server 216 is to maintain and manage the remote desktop sessions for users.

At 712 (“EVENT OCCURS”), an event for the configured/monitored local application occurs at the user device-A 146-A. The application event tracker 516 at the user device-A 146-A detects the event and sends the detected event (and/or information pertaining to the detected event) to the application event handler 512 at the user device-A 146-A, at 714 (“SEND EVENT TO APP EVENT HANDLER”).

Turning now and continuing to FIG. 8, the application event handler 512 at the user device-A 146-A sends the information pertaining to the event to the connection server 261, at 800 (“SEND APP EVENT INFORMATION”), since the remote desktop session on the user device-A 146-A has been disconnected. At 802 (“RETURN CONNECTION INFORMATION AND APP EVENT INFORMATION”), the connection server 216 returns, to the client-B 502, the connection information for client-A 500 and also the information pertaining to the event that has occurred.

At 804 (“GENERATE NOTIFICATION”), the application event handler 526 at the user device-B 146-B generates the notification 310 that is displayed over the remote desktop 126 on the display screen of the user device-B 146-B. The notification 310 includes buttons 312 and 314, and prompts the user to select whether to handle the event now or later/ignore. The notification 310 in some embodiments may also indicate to the user that the event has occurred at the other user device-A 146-A.

As before, the notification 310 may disappear, if the user does not timely make a selection or clicks the button 314. If the use clicks the button 312 to handle the event now, then the client-B 502 contacts the client-A 500 so as to establish a remote desktop session between the user device-B 146-B and the user device-A 146-A, at 806 (“IF USER CHOOSES TO HANDLE EVENT, ESTABLISH REMOTE SESSION TO SHARE DESKTOP”). In this scenario, the user device-B 146-B operates as a client device, and the user device-A 146-A operates as a server that shares the local desktop of the user device-A 146-A with the user device-B 146-B. Thus, the local desktop of the user device-A 146-A becomes another remote desktop that is rendered on the display screen of the user device-B 146-B.

According to various embodiments, any remote session between a client (e.g., the client-B 502 at the user device-B 146-B) and a remote desktop (e.g., the user device-A 146-A that will share its local desktop, or a remote desktop provided by the agent 504) involves the connection server 216 first requesting a session token from the remote desktop and returning the session token to the client, which would then use the session token to establish a connection with the remote desktop. This procedure may be followed at 610, 708, 806, etc.

According to various embodiments, the entire local desktop of the user device-A 146-A is not rendered over the display screen of the user device-B 146-B, which is currently rendering the remote desktop 126 from the agent 504. Rather, the client-A 500 sends a cropped window 400 of the local application (running on the user device-A 146-A and which has experienced the event) to the client-B 502, at 808 (“SEND CROPPED APP WINDOW”). For example, the client-A 500 may crop the graphical data of the local desktop of the user device-A 146-A based on the size of the window 400 of the local application, and send only the graphical data of the window 400 to the user device-B 146-B.

The client-B 502 then displays the window 400 over the remote desktop 126 on the display screen of the user device-B 146B, at 810 (“”DISPLAY APP WINDOW OVER REMOTE DESKTOP”), so that the user can directly view/operate the local application (which is running on the other user device-A 146-A). The user may then handle the event (e.g., conduct a call/meeting) by interacting with the window 400. For example, mouse, keyboard, screen, etc. actions performed at the user device-B 146-B may be conveyed by the MKS client 524 at the user device-B 146-B to the MKS server 510 at the user device-A 146-A. Furthermore, data of the application (such as audio and/or video data, etc.) can be transferred between the user device-A 146-A and the user device-B 146-B, at 812 (“TRANSFER DATA OF APP”), so that the application (e.g., Teams, Slack, etc.) can operate properly during the session.

At 814 (“DESTROY CONNECTION”), the connection between the client-B 502 and the client-A 500 is destroyed/disconnected when the user closes the window 400 of the application. At that point, the user can then resume working at the user device-B 146-B with the remote desktop 126 provided by the agent 504.

From the embodiments disclosed herein, several benefits are realized. A more seamless working experience may be provided for end users to work anywhere. With the techniques/features disclosed herein, the boundary between a local user device and remote desktop is blurred. Meanwhile, the boundary between multiple local user devices is blurred too.

Also, the techniques/features disclosed herein reduce the possibility of users missing any application events when the users are working on remote desktops via multiple local user devices, even if these local user devices are not located closely at same place.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-8. For example, computing devices capable of acting as agent-side host devices or client-side user devices may be deployed in or otherwise operate in conjunction with the virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances (VCIs) may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to handle events associated with local applications, the method comprising:
using, on a first user device, a first remote desktop during a first remote desktop session, wherein the first remote desktop fully occupies a first display screen of the first user device to obscure a local desktop of the first user device;
detecting a first event associated with at least one local application that runs on the first user device;
in response to detecting the first event, displaying a first notification of the first event over the first remote desktop that occupies the first display screen, wherein the first notification provides at least one selection option that pertains to handling of the first event; and
in response to the at least one selection option being selected to handle the first event, displaying a window of the at least one local application over the first remote desktop that occupies the first display screen.

2. The method of claim 1, wherein in response to the at least one selection option being selected to ignore the event or in response to expiration of an amount of time, the first notification disappears from the first display screen of the first user device.

3. The method of claim 1, wherein displaying the window of the at least one local application includes displaying only the window of the at least one local application over the first remote desktop, with other portions of the local desktop outside of the window being cropped.

4. The method of claim 1, further comprising:
using, on a second user device, a second remote desktop during a second remote desktop session, wherein the second remote desktop fully occupies a second display screen of the second user device to obscure a local desktop of the second user device;
detecting a second event associated with the at least one local application that runs on the first user device;
in response to detecting the second event, displaying a second notification of the second event over the second remote desktop that occupies the second display screen, wherein the second notification provides at least one selection option that pertains to handling of the second event; and
in response to the at least one selection option being selected to handle the second event:
establishing a connection between the second user device and the first user device; and
displaying, using the established connection, the window of the at least one local application over the second remote desktop that occupies the second display screen, wherein the displayed window serves as part of another remote desktop on the second display screen.

5. The method of claim 4, further comprising:
cropping the local desktop of the first user device, so that only the window of the at least one application is displayed over the second remote desktop;
using mouse, keyboard, and screen actions performed at the second user device to interact with the at least one application that runs on the first user device; and
transferring data of the at least one application between the first user device and the second user device to enable the second event to be handled from the second user device.

6. The method of claim 4, further comprising:
sending, by the first user device, configuration information to a connection server, wherein the configuration information specifies the at least one application and events associated with the at least one application that are to be monitored;
disconnecting the first remote desktop session of the first user device so as to enable the second user device to use the second remote desktop during the second remote desktop session; and
after disconnecting the first remote desktop session, receiving the configuration information and connection information by the second user device from the connection server, wherein the second user device uses the connection information and the configuration information to generate the second notification and to establish the connection with the first user device.

7. The method of claim 1, wherein the first event includes at least one of an incoming email, an incoming call, an upcoming meeting, or a calendar event.

8. A non-transitory computer-readable medium having instructions stored thereon, which in response to execution by one or more processors, cause the one or more processors to perform a method to handle events associated with local applications, wherein the method comprises:
using, on a first user device, a first remote desktop during a first remote desktop session, wherein the first remote desktop fully occupies a first display screen of the first user device to obscure a local desktop of the first user device;
detecting a first event associated with at least one local application that runs on the first user device;
in response to detecting the first event, displaying a first notification of the first event over the first remote desktop that occupies the first display screen, wherein the first notification provides at least one selection option that pertains to handling of the first event; and
in response to the at least one selection option being selected to handle the first event, displaying a window of the at least one local application over the first remote desktop that occupies the first display screen.

9. The non-transitory computer-readable medium of claim 8, wherein in response to the at least one selection option being selected to ignore the event or in response to expiration of an amount of time, the first notification disappears from the first display screen of the first user device.

10. The non-transitory computer-readable medium of claim 8, wherein displaying the window of the at least one local application includes displaying only the window of the at least one local application over the first remote desktop, with other portions of the local desktop outside of the window being cropped.

11. The non-transitory computer-readable medium of claim 8, wherein the method further comprises:
using, on a second user device, a second remote desktop during a second remote desktop session, wherein the second remote desktop fully occupies a second display screen of the second user device to obscure a local desktop of the second user device;
detecting a second event associated with the at least one local application that runs on the first user device;
in response to detecting the second event, displaying a second notification of the second event over the second remote desktop that occupies the second display screen, wherein the second notification provides at least one selection option that pertains to handling of the second event; and
in response to the at least one selection option being selected to handle the second event:
establishing a connection between the second user device and the first user device; and
displaying, using the established connection, the window of the at least one local application over the second remote desktop that occupies the second display screen, wherein the displayed window serves as part of another remote desktop on the second display screen.

12. The non-transitory computer-readable medium of claim 11, wherein the method further comprises:
cropping the local desktop of the first user device, so that only the window of the at least one application is displayed over the second remote desktop;
using mouse, keyboard, and screen actions performed at the second user device to interact with the at least one application that runs on the first user device; and
transferring data of the at least one application between the first user device and the second user device to enable the second event to be handled from the second user device.

13. The non-transitory computer-readable medium of claim 11, wherein the method further comprises:
sending, by the first user device, configuration information to a connection server, wherein the configuration information specifies the at least one application and events associated with the at least one application that are to be monitored;
disconnecting the first remote desktop session of the first user device so as to enable the second user device to use the second remote desktop during the second remote desktop session; and
after disconnecting the first remote desktop session, receiving the configuration information and connection information by the second user device from the connection server, wherein the second user device uses the connection information and the configuration information to generate the second notification and to establish the connection with the first user device.

14. The non-transitory computer-readable medium of claim 8, wherein the first event includes at least one of an incoming email, an incoming call, an upcoming meeting, or a calendar event.

15. A system, comprising:
a first processor of a first user device; and
a first non-transitory computer-readable medium coupled to the first processor and having instructions stored thereon, which in response to execution by the first processor, cause the first processor to perform first operations to handle events associated with local applications, wherein the first operations comprise:
use, on the first user device, a first remote desktop during a first remote desktop session, wherein the first remote desktop fully occupies a first display screen of the first user device to obscure a local desktop of the first user device;
detect a first event associated with at least one local application that runs on the first user device;
in response to detection of the first event, display a first notification of the first event over the first remote desktop that occupies the first display screen, wherein the first notification provides at least one selection option that pertains to handling of the first event; and
in response to the at least one selection option being selected to handle the first event, display a window of the at least one local application over the first remote desktop that occupies the first display screen.

16. The system of claim 15, wherein in response to the at least one selection option being selected to ignore the event or in response to expiration of an amount of time, the first notification disappears from the first display screen of the first user device.

17. The system of claim 16, wherein the first operations to display the window of the at least one local application includes first operations to display only the window of the at least one local application over the first remote desktop, with other portions of the local desktop outside of the window being cropped.

18. The system of claim 15, further comprising:
a second processor of a second user device; and
a second non-transitory computer-readable medium coupled to the second processor and having instructions stored thereon, which in response to execution by the second processor, cause the second processor to perform second operations to handle events associated with local applications, wherein the second operations comprise:
use, on the second user device, a second remote desktop during a second remote desktop session, wherein the second remote desktop fully occupies a second display screen of the second user device to obscure a local desktop of the second user device;
detect a second event associated with the at least one local application that runs on the first user device;
in response to detection of the second event, display a second notification of the second event over the second remote desktop that occupies the second display screen, wherein the second notification provides at least one selection option that pertains to handling of the second event; and
in response to the at least one selection option being selected to handle the second event:
establish a connection between the second user device and the first user device; and
display, using the established connection, the window of the at least one local application over the second remote desktop that occupies the second display screen, wherein the displayed window serves as part of another remote desktop on the second display screen.

19. The system of claim 18, wherein the second operations further comprise:
display only the window of the at least one application over the second remote desktop, with portions of the local desktop of the first user device that lie outside of the window being cropped;
use mouse, keyboard, and screen actions performed at the second user device to interact with the at least one application that runs on the first user device; and
transfer data of the at least one application between the first user device and the second user device to enable the second event to be handled from the second user device.

20. The system of claim 15, wherein the first operations further comprise:
send, by the first user device, configuration information to a connection server, wherein the configuration information specifies the at least one application and events associated with the at least one application that are to be monitored; and
disconnect the first remote desktop session of the first user device so as to enable the second user device to use the second remote desktop during the second remote desktop session,
wherein after disconnection of the first remote desktop session, the second user device receives the configuration information and connection information from the connection server, and wherein the second user device uses the connection information and the configuration information to generate the second notification and to establish the connection with the first user device.

21. The system of claim 15, wherein the first event includes at least one of an incoming email, an incoming call, an upcoming meeting, or a calendar event.
